(19) United States
(12) Patent Application Publication
(10) Pub. No.: US 2025/0137434 A1
(43) Pub. Date: May 1, 2025

(54) WATER TURBINE SYSTEM AND METHOD OF USE

(71) Applicant: Robert W Jenkins, IV, Columbia, MO (US)

(72) Inventor: Robert W Jenkins, IV, Columbia, MO (US)

(21) Appl. No.: 18/928,942

(22) Filed: Oct. 28, 2024

Related U.S. Application Data
(60) Provisional application No. 63/546,003, filed on Oct. 27, 2023.

(51) Int. Cl. F03B 17/06

(52) U.S. Cl. CPC F03B 17/061; F05B 2220/706; F05B 2240/93

(57) ABSTRACT

A water turbine system for providing electrical power from the flowing of water through a canal element. This invention is ideally suited for placement in a flowing river, but any flowing body of water should provide the necessary kinetic energy for the present invention to function. The turbine could be formed from a modified combine pickup wheel. The system could include a floating barge within the flowing body of water containing an interior channel over which the turbines are affixed.

### CROSS-REFERENCE TO RELATED APPLICATION

This application claims priority in U.S. Provisional Patent Application No. 63/546,003 Filed Oct. 27, 2023, which is incorporated herein by reference.

### BACKGROUND OF THE INVENTION

### 1. Field of the Invention

The present invention relates generally to water turbine system and method for use thereof, and more specifically to a floating canal with turbines for generating electrical power from flowing water.

### 2. Description of the Related Art

Trying to capture the kinetic energy from moving water to generate usable electricity from a renewable, clean source has been a high priority for many years. Existing systems attempt to harness power from waves or flowing water using buckets, turbines, and other devices. However, these existing systems do not take into consideration the potential damage to the environment, including river beds and river animal life, and have not been able to adequately protect those existing devices from debris and other hazards.

Heretofore there has not been available a system or method for a water turbine system with the advantages and features of the present invention.

### BRIEF SUMMARY OF THE INVENTION

The present invention generally provides a water turbine system for providing electrical power from the flowing of water through a canal element. This invention is ideally suited for placement in a flowing river, but any flowing body of water should provide the necessary kinetic energy for the present invention to function.

The turbine could be formed from a modified combine pickup wheel, such as that produced by the J. E. Love Company of Garfield, Washington shown at:
https://www.jeloveco.com/parts/M-76,M-76N,M-76W_Pickup_Reel_Operating, Setup,&Parts_Illustrations.pdf, last accessed Oct. 22, 2024, the document linked to which is incorporated herein by reference. Any suitable combine pickup wheel from any manufacturer could be modified to suit the needs of the present invention and to be formed into a water turbine.

The canal element is a three-sided device with a first side, a second side, and a floor. The canal includes one elongated side (e.g. the first side) and one flared out short side (e.g. the second side) to maximize the volume of water flowing through the system and to counteract the water being blocked due to the debris shield. The lack of a top or roof to the canal further maximizes the possible volume flow throughput.

In a preferred embodiment, the first side faces the river bank or shore side to allow debris to skim along the wall like a shield. A debris shield will be located at the entrance to prevent debris from clogging the channel. The debris shield is angled to send the debris along the river-side of the apparatus. Ideally, the first side is parallel with the riverbank. The open end faces upstream.

The canal element may be suspended from flotation devices within a river or other flowing body of water. Work barges could be used as the flotation device. Floating the canal element minimizes pinch points to avoid harming fish or other marine life.

The exiting end of the canal may include a flared opening to allow for exiting water to flow into a void, maximizing velocity of flow through the canal.

Turbines are suspended from the barges, laid across the canal, and are lowered into the flowing water. These turbines capture the kinetic energy from the passing water by turning the turbine which turns generators, thereby creating true base load renewable electricity. This electricity is transferred to shore via power lines from the barges to a shore pole. Covers may be used to protect the equipment from weather.

The generator could be any typical generator for electrical power.

In one embodiment, the turbine includes bats which maintain a straight vertically up-and-down orientation as they enter the water and are pushed back by the water, thereby forcing the bat deeper into the water without lifting against the water.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention shown in a first, deployed orientation.

FIG. 2 is a three-dimensional partially-exploded isometric view thereof.

FIG. 3 is a top plan view of the embodiment of FIG. 1.

FIG. 4 is a three-dimensional isometric view of a turbine element of the present invention.

FIG. 5 is a three-dimensional exploded isometric view thereof.

FIG. 6 is a side elevational view of the turbine element of FIG. 4.

FIG. 7 is a front elevational view thereof.

FIG. 8 is a flowchart diagramming the steps taken to practice an embodiment of the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Water Turbine System 2

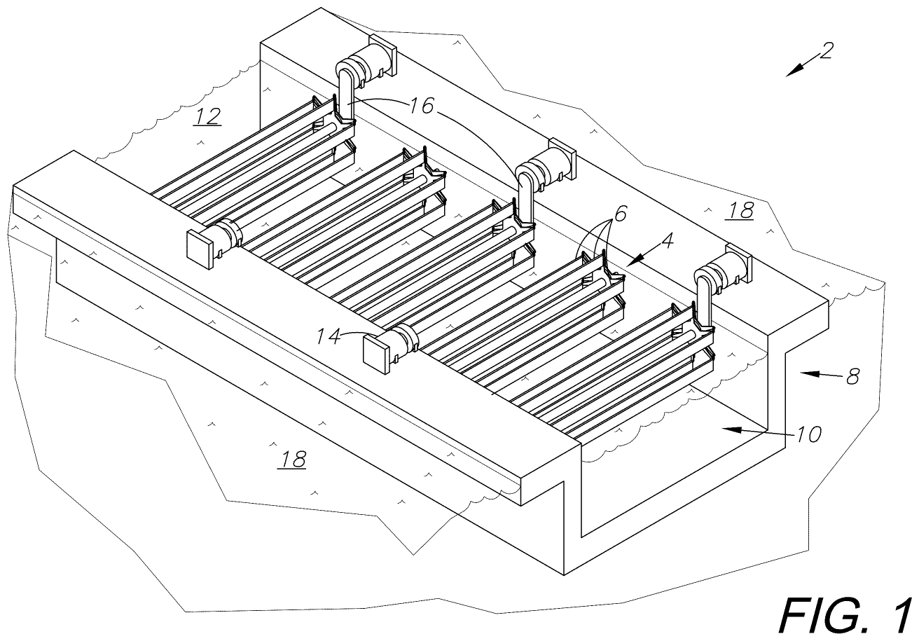

As shown in the figures, a prior art combine pickup wheel, such as that produced by the J. E. Love Company of Garfield, Washington shown at:
https://www.jeloveco.com/parts/M-76,M-76N,M-76W_Pickup_Reel_Operating,Setup,&Parts_Illustrations.pdf, last accessed October 22, could be retrofitted to serve as a turbine embodiment for the present invention. FIG. 1 shows a preferred embodiment water turbine system 2, where turbines 4 are laid across a canal system 8 which is kept afloat via floatation barges within a river 16 or other flowing water environment. The turbines 4 could be the above-identified pickup reels, modified existing pickup reels, or proprietary or pre-existing water wheel turbines.

When modifying the pickup reel to serve as a turbine for the present invention, the connected reel elements connected to the reel connectors 30 all become bats 6 and those bats would extend further away to reach the water. The single shaft 26 can also be modified into a bat that exists both above and below the shaft with a connection element to hold the second bat in place. Bracing may be required to support larger bats.

In this modification of the pickup reel, the drive motor of the original product is not needed. Instead, a gear or pully on the end 24 of the center shaft 26 would be used to transfer mechanical energy to a generator connected to the turbine to create power.

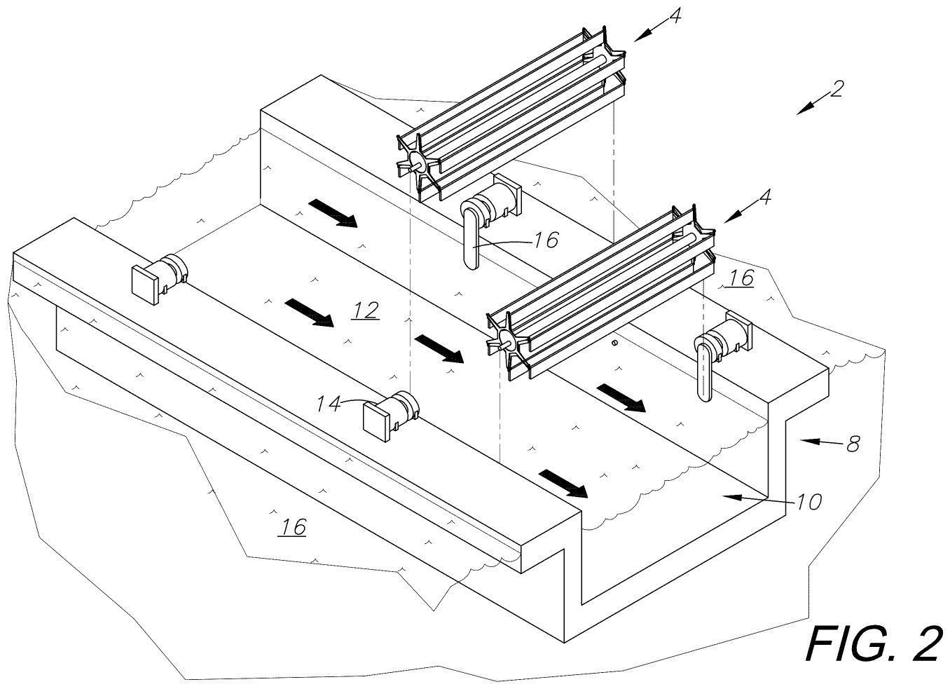

FIG. 2 shows how the turbine 4 is connected to the canal system 8 and the generators 14. The canal system 8 includes a channel 10 which contains the water flow 12 which powers the turbines 4. The canal system 8 could be formed from a working barge which floats away from shore in the flowing water source, and includes a base and a pair of sides 9 to which the generators 14 can be mounted. These turbines 4 would be mechanically connected to generators 14. These generators can then be connected to an electrical pole or other suitable connection on shore. The system 2 could also be designed to be deployed along the edge of a river, in-place canal, or other flowing body of water, or into a constructed, permanent canal with suitable flow.

The canal system 8 could also be constructed from one or more floating elements which form the working barge. The floating elements could be constructed in a way to create an inlet to the channel 10, and may include a flared exit from the channel to help force water out and away from the floating barge elements.

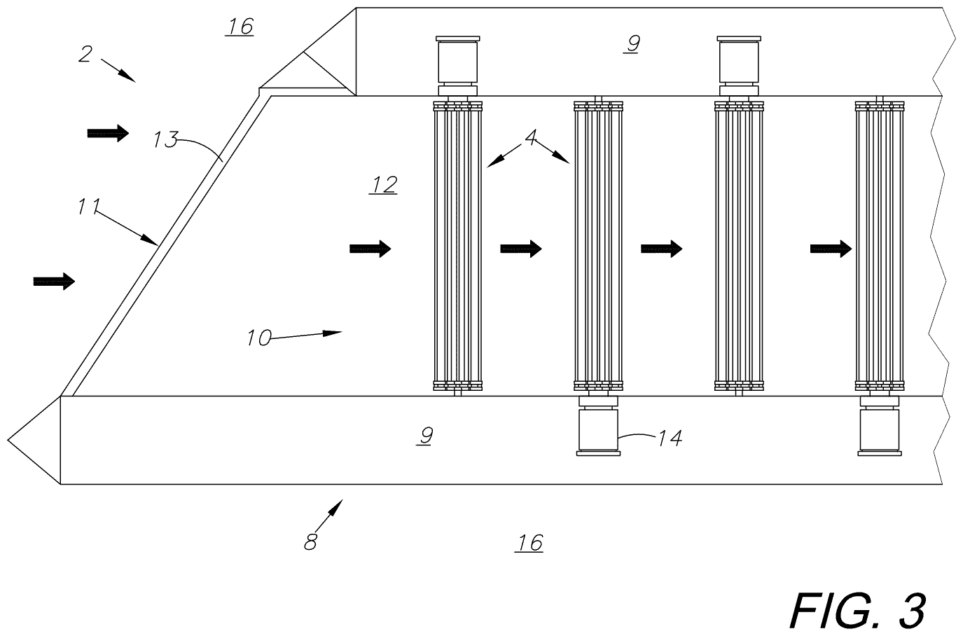

As shown in FIG. 3, a debris shield 13 is provided at the inlet 11 of the channel 10. This shield could be formed from multiple different mesh or bar sizes, or varying combinations thereof, to protect the system from debris flowing in the water down the canal, the canal flow 12 being the water that passes the turbines 4. This shield can be angled to help deflect debris around the system as well. A V-shaped shield could also be deployed, depending on need. This is very important for running rivers because logs, garbage, and even ice during spring melt could cause issues with the turbines.

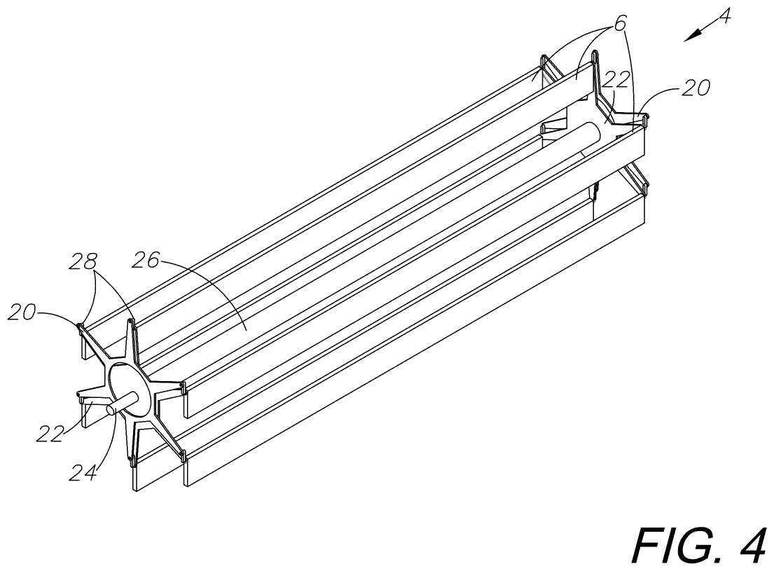

FIG. 4 shows the modified pickup wheel as a turbine 4. The turbine as shown 4 includes a pair of outer wheels 20 and inner wheels 22 mounted offset at the ends 24 of the shaft 26. The two wheels 20, 22 are connected via offset connectors 28. The inner wheels 22 are connected to the reel connectors 30 which connect to the bats 6.

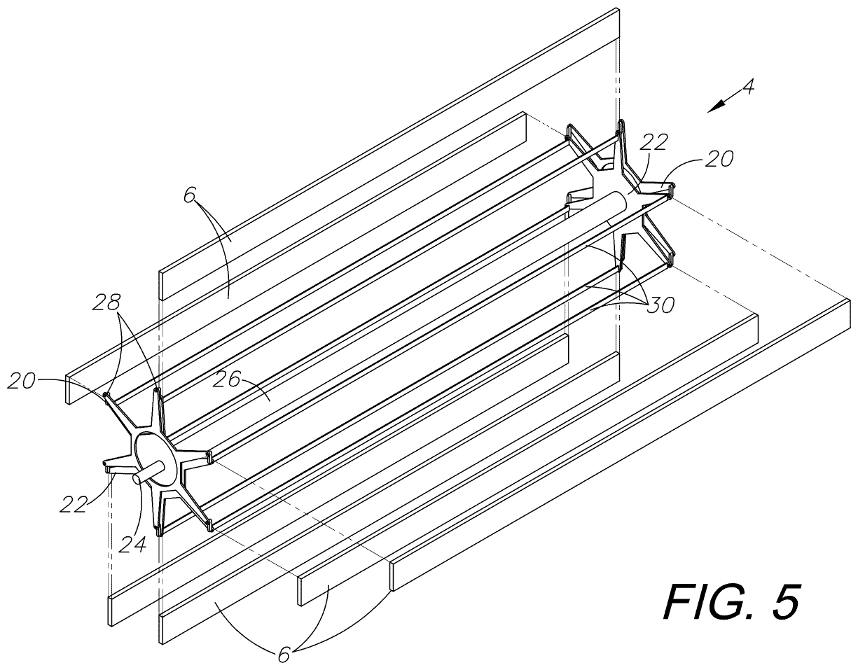

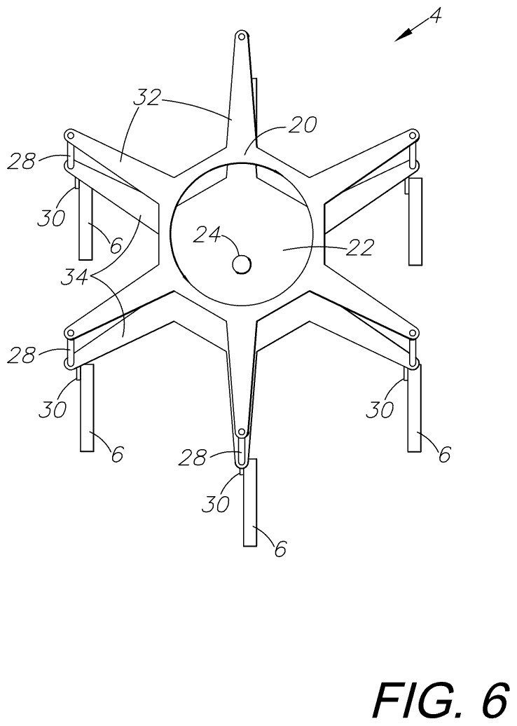

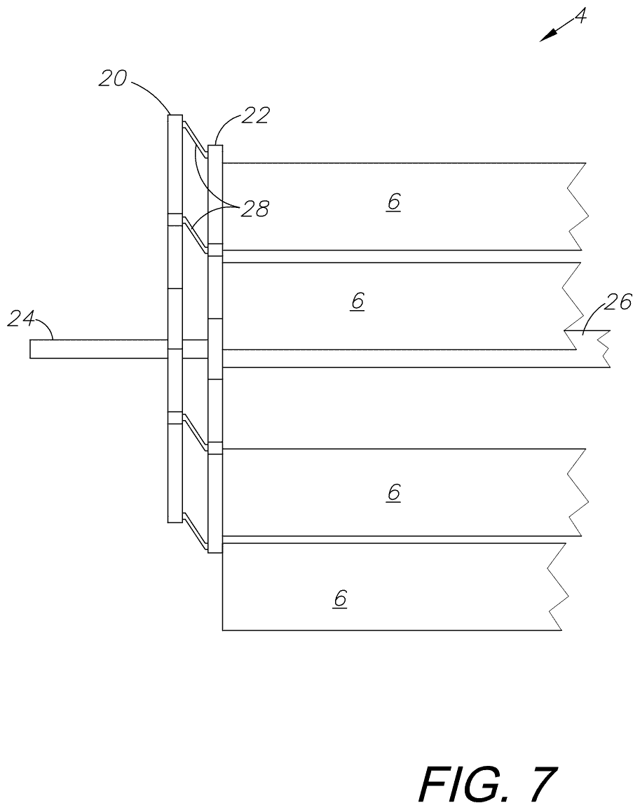

FIGS. 5-7 show the turbine 4 in additional views. The outer wheel 20 could include a number of spokes 32, and the inner wheel 22 could similarly include a number of spokes 34.

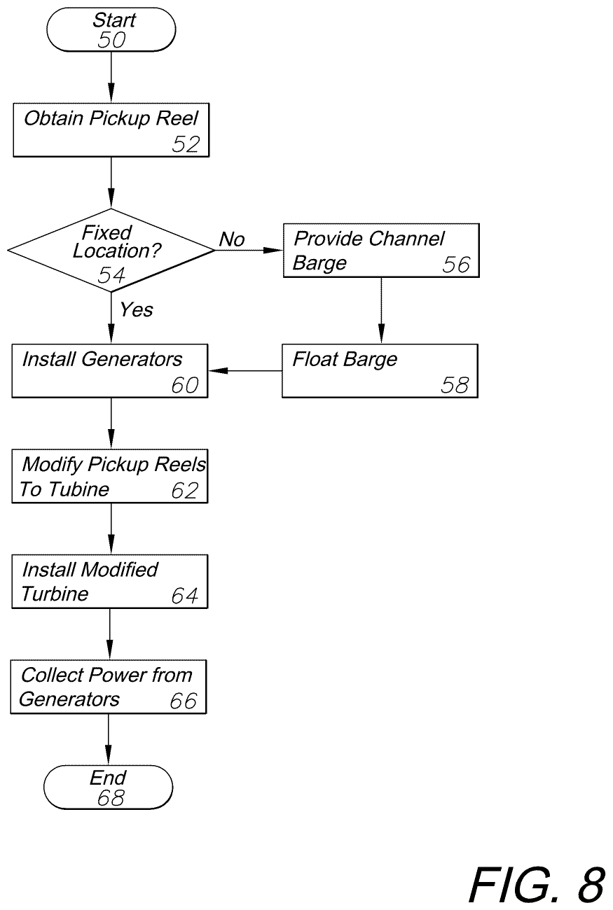

FIG. 8 is a flowchart diagramming the steps taken in practicing a preferred embodiment of the present invention. The method starts at 50 and a pickup reel is obtained at 52. This could also be replaced with any suitable turbine.

At 54 a determination of placement is made. If the location isn't permanently fixed, a channel barge is provided at 56 and it is floated in the water source at 58.

Generators are installed at the site or on the barge at 60. If the generators obtained at 52 were pickup reels, those pickup reels are modified into the turbines at 62. The turbines are installed at 64. Power is collected from the turbines via generators at 66. The process then ends at 68.

It is to be understood that while certain embodiments and/or aspects of the invention have been shown and described, the invention is not limited thereto and encompasses various other embodiments and aspects.

The invention claimed is:

1. A water turbine system comprising:
a turbine;
a generator affixed to a surface adjacent to a source of flowing water within a channel;
said turbine extending across said channel, such that said source of flowing water turns said turbine;
said turbine connected to said generator such that said turbine powers said generator; and
said generator connected to an external power grid, whereby said generator delivers power to said external power grid.

2. The water turbine system of claim 1, further comprising:
said turbine comprising a modified pickup reel assembly;
whereby said pickup reel assembly is modified by affixing bats to reel connectors of said pickup reel assembly; and
whereby said bats contact said source of flowing water, thereby turning said turbine.

3. The water turbine system of claim 1, further comprising:
said turbine comprising a central shaft;
at least one bat being affixed to said central shaft; and
whereby said at least one bat contacts said source of flowing water, thereby turning said turbine.

4. The water turbine system of claim 1, further comprising:
said generator affixed to a top face of a floating barge assembly;
said floating barge assembly deployed within said source of flowing water; and
said floating barge having an interior comprising said channel.

5. The water turbine system of claim 4, further comprising:
said floating barge comprising a debris shield located about an intake end of said channel; and
said debris shield configured to deflect debris away from said channel, thereby preventing debris from entering said channel.

6. A water turbine system comprising:
a floating structure constructed from at least one structural element such that said floating structure comprises a base and a pair of side walls forming a channel, said floating structure configured to be placed within a flowing body of water;
said channel configured to receive a portion of water from said flowing body of water, such that said portion of water flows through said channel from an inlet to an outlet;
a debris shield installed at said inlet of said floating structure, said debris shield configured to deflect debris within said flowing body of water away from said channel;
a generator affixed to one of said pair of side walls such that it is placed adjacent to said portion of water through said channel;
a turbine placed within said channel, such that said portion of water within said channel turns said turbine;
said turbine connected to said generator such that said turbine powers said generator; and
said generator connected to an external power grid, whereby said generator delivers power to said external power grid.

7. The water turbine system of claim 6, further comprising:
said turbine comprising a modified pickup reel assembly;
whereby said pickup reel assembly is modified by affixing bats to reel connectors of said pickup reel assembly; and
whereby said bats contact said source of flowing water, thereby turning said turbine.

8. The water turbine system of claim 6, further comprising:
said turbine comprising a central shaft;
at least one bat being affixed to said central shaft; and
whereby said at least one bat contacts said source of flowing water, thereby turning said turbine.
